(19) United States
(12) Patent Application Publication
(10) Pub. No.: US 2007/0158873 A1
(43) Pub. Date: Jul. 12, 2007

(54) Process for making a shoe inner sole

(75) Inventor: Hermann Beck, Pirmasens (DE)

Correspondence Address: D. PETER HOCHBERG CO. L.P.A., 1940 EAST 6TH STREET, CLEVELAND, OH, 44114, US

(73) Assignee: CAPRICE Schuhproduktion GmbH & Co. KG, Pirmasens (DE)

(21) Appl. No.: 11/710,705

(22) Filed: Feb. 26, 2007

Related U.S. Application Data
(62) Division of application No. 10/450,866, filed on Feb. 17, 2004.

(30) Foreign Application Priority Data
Aug. 4, 2000 (DE) 100 38 216.9

(51) Int. Cl. B28B 7/22

(52) U.S. Cl. 264/255; 264/319

(57) ABSTRACT

A process for producing an inner sole including a sole base and a plurality of blisters integrally formed on the sole base and extending away from the sole base, the process comprising the steps of preparing a mold with a recess for forming the sole base and the blisters, the recess having a number of projections on a first area and clearances for forming hollow spaces on an opposite second area, preparing a flexible elastic material, introducing material into the mold to form the sole base with integral blisters, and removing the inner sole from the mold.

### CROSS REFERENCE TO RELATED APPLICATION

This application is a division of U.S. patent application Ser. No. 10/450,866 filed Feb. 17, 2004.

### FIELD OF THE INVENTION

The present invention relates to a process for molding an inner sole for a shoe, in particular a sports, leisure or climbing shoe and/or boot, the inner sole having blisters.

### BACKGROUND OF THE ART

In the prior art there is described, for example in DE-A-37 32 495, an intermediate sole for a shoe which has an inlay and a peripheral part. A number of solid supporting elements extend downward from a base of the inlay. The supporting elements are of such a height that they correspond to the rise or elevation of the peripheral part from the tip of the foot to the heel. The damping properties of the inlay are intended to be adaptable to the respective weight of the wearer, in that an appropriately selected inlay is inserted into the shoe. However, this inlay sole continues to leave something to be desired with regard to its damping properties and wearing comfort.

DE-A-36 35 831 describes an outsole for footwear with a sole surface on the foot side into which a uniform recess is introduced. Inserted flush into the recess is a blistered sheet. The blistered sheet comprises a base sheet which bears closely and regularly distributed blisters, with intermediate spaces remaining between the blisters. The upper sides of the blisters are preferably curved and are covered by a cover sheet. According to one embodiment, the blisters are hollow and have openings on the upper side.

DE-U-89 00 237 describes an inner sole with an upper side which is formed by a base sheet with a multiplicity of blisters regularly distributed on it, a layer facing the sole of the foot, made of a material such as leather or textile, and also a perforation. This layer is applied to the rear side of the base sheet, facing away from the blisters, and the tops of the blisters are connected to the sole.

### SUMMARY OF THE INVENTION

It is an object of the present invention to provide an improved inner sole for a shoe which allows, in particular, individually adaptable damping properties and improved wearing comfort of the shoe. This object is achieved by the features of the independent patent claims. Preferred embodiments of the present invention are contained in the dependent patent claims.

The invention is in this case based on the fundamental idea of providing the inner sole with a number of hollow protuberances in the form of blisters, which are provided substantially over the entire sole area, on its underside. The inner sole and blisters are formed in one process step. For this purpose, either a single material is used for the entire sole construction or a number of different materials are used for different regions of the sole. Both variants permit optimal adaptation of the inner sole according to the invention to a foot of a wearer of a shoe provided with this sole, with optimal damping properties being achieved at the same time.

To achieve the object described above, the invention is also based on the fundamental idea of providing an inner sole with blister-like protuberances which point away from an underside of a foot of a wearer of a shoe provided with the inner sole according to the invention, the inner sole having perforations, at least in certain portions. These perforations may be provided in the intermediate space between the individual blisters, through the blisters or both in the intermediate spaces and in the blisters. The perforations serve in particular for dissipating moisture, such as perspiration for example, from the foot of the wearer of the shoe. In particular in the case of the perforated blisters, an effect similar to a pump occurs during use of a shoe provided with the inner sole according to the invention, with the effect that the moisture is dissipated from the foot in a particularly advantageous way.

A combination of the two basic principles described above of the inner sole according to the invention produces an inner sole which can be formed or adapted optimally to the shape of a user's foot, which at the same time permits optimal wearing comfort. It is in this respect advantageous in particular that the inner sole according to the invention has blisters which, independently of one another and each by themselves, provide a “cushion effect” or damping effect and also ventilation with every step. The result is a continuous adaptation of the inner sole according to the invention to every step and every shape of foot of a user. In this case, the foot remains optimally cooled and is individually damped in a particularly advantageous way. The inner sole according to the invention is described below on the basis of a preferred embodiment with reference to the accompanying drawings, in which:

### BRIEF DESCRIPTION OF THE DRAWINGS

FIG. 1 shows a schematic representation of the inner sole according to the invention from below.

FIG. 2 shows a view from below of the inner sole according to the invention.

FIG. 3 shows a section along the line A-A in FIG. 2.

FIG. 4 shows a section along the line B-B in FIG. 2.

FIG. 5 shows a section along the line C-C in FIG. 2.

FIG. 6 shows a section along the line D-D in FIG. 2.

FIG. 7 shows an enlarged, perspective and partly sectioned representation of the blisters of the inner sole according to the invention.

FIG. 8 shows a perspective, partly sectioned representation similar to FIG. 7, fluid dissipated from the foot of a user by perforations being schematically represented.

FIG. 9 shows a spatial representation of a sole construction with the inner sole according to the invention under a user's foot.

FIG. 10 shows a diagram of the pressure distribution on the foot of a user of a shoe with the inner sole according to the invention. and

FIG. 11 shows a diagram of the pressure distribution on the foot of a user in the shoe according to FIG. 10 without the inner sole according to the invention.

### DETAILED DESCRIPTION OF THE INVENTION

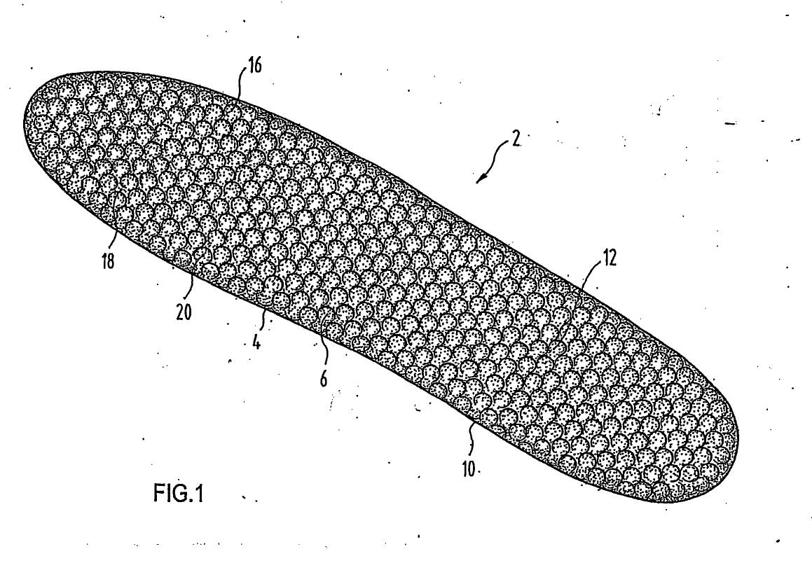

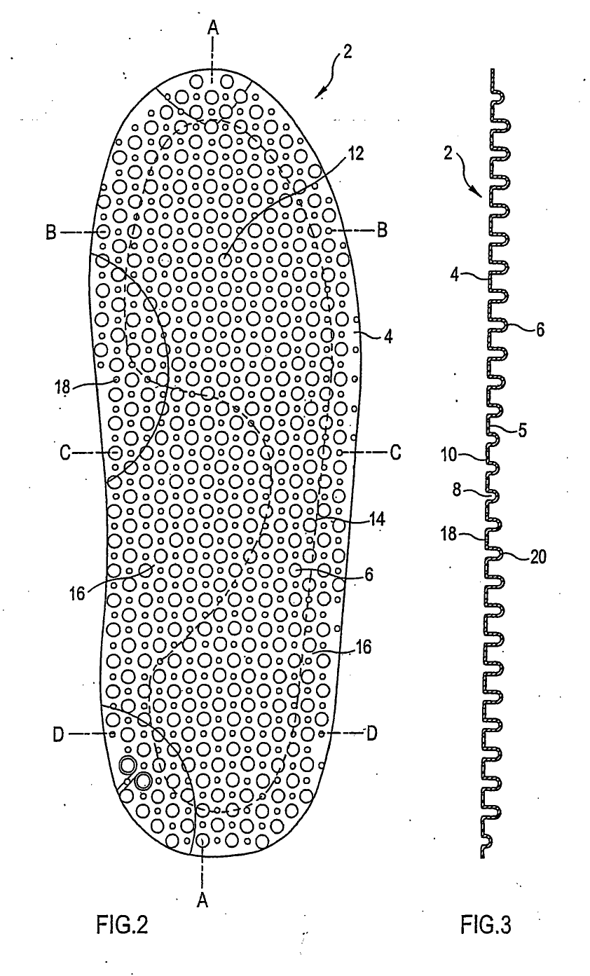

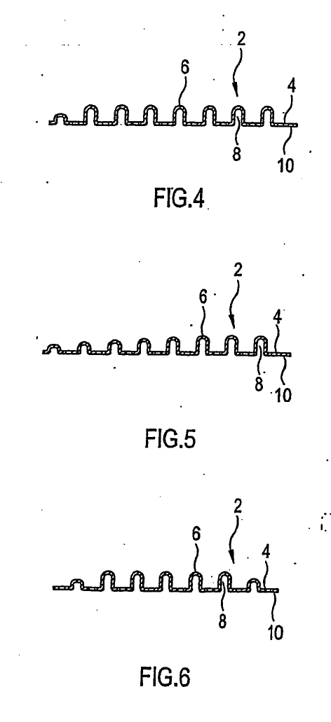

The inner sole 2 according to the invention is shown in more detail in FIGS. 1 to 6 and substantially has a sole base 4 and a multiplicity of protuberances 6 in the form of blisters formed integrally with it. The protuberances or blisters 6 are preferably formed substantially over the entire underside of the inner sole 2. The blisters 6 are preferably positioned relatively close to one another, so that an only small distance of, for example, 0.3 to 3 mm, preferably of 0.4 to 1.0 mm, and particularly preferably of about 0.5 mm, is provided between the individual blisters 6. The blisters 6 preferably have a regular arrangement, for example in the form of a close packing. As shown in FIG. 2, in this case the shortest distance between the blisters is provided in the diagonal direction of the sole 2.

According to the preferred embodiment represented in the figures, the blisters 6 have a hollow space, which is open toward the upper side 10 of the sole. The form of the blisters may be substantially the same in a central region 12, which is schematically shown in FIG. 2 by a dashed line 14, while particularly the height of the blisters, and consequently also the diameter, may vary in an edge region 16 outside the line 14. In this region, the blisters are preferably lower and have a smaller diameter. The blisters 6 may be formed differently both in the central region 12 and in the edge region 16, in a way corresponding to the sectional representations of FIGS. 3 to 6. The central region 12 may also be chosen such that only the outermost blisters 6 along the entire periphery of the sole are respectively formed lower. The blisters 6 provided in the central region 12 preferably have at their base an outside diameter of between 6.5 and 7.5 mm, preferably about 7 mm, an inside diameter of between 4.5 and 5.5 mm, preferably about 5 mm, and a wall thickness in the range between 0.9 and 1.3 mm, preferably between 1.0 and 1.2 mm. The wall thickness preferably diminishes from the base of the blisters 6 to their dome-shaped end, so that, for example, the wall thickness at the base is 1.2 mm and in the region of the dome is 1.0 mm. The height of the blisters 6 lies, for example, between 3 and 10 mm, preferably between 5 and 8 mm and particularly preferably at about 6 mm. In the edge region 16 of the inner sole 2, the blister height may also be lower, however, in a way corresponding to the statements made above, and be, for example, only a few tenths of a millimeter. The thickness of the base 4 of the inner sole 2 lies, for example, between 0.5 and 1.5 and preferably between 0.8 and 1.2 mm.

The wall thicknesses, heights, diameters and/or materials of the blisters or of the entire inner sole may vary in ranges, in order in particular to be adapted to various shapes of foot, dimensions, types of stress or uses. The hardness of the material used usually lies in the range between 35 and 60, preferably between 40 and 45 Shore A. Coming into consideration as materials are, for example, elastomers, latex, block copolymers, thermoelastics, rubbers, in particular thermoplastic rubbers (TPR), synthetic rubbers and natural rubbers. For selecting the suitable material, it is important that it has adequate hardness and adequate rubber-elastic characteristics at the temperature at which it is used. Particularly preferred are latex materials and thermoplastic rubbers (TPR).

Described below is a further embodiment of the present invention, which not only can be combined with the first embodiment described above, as for example schematically shown in FIG. 2, but also achieves the object on which the invention is based independently of the first embodiment.

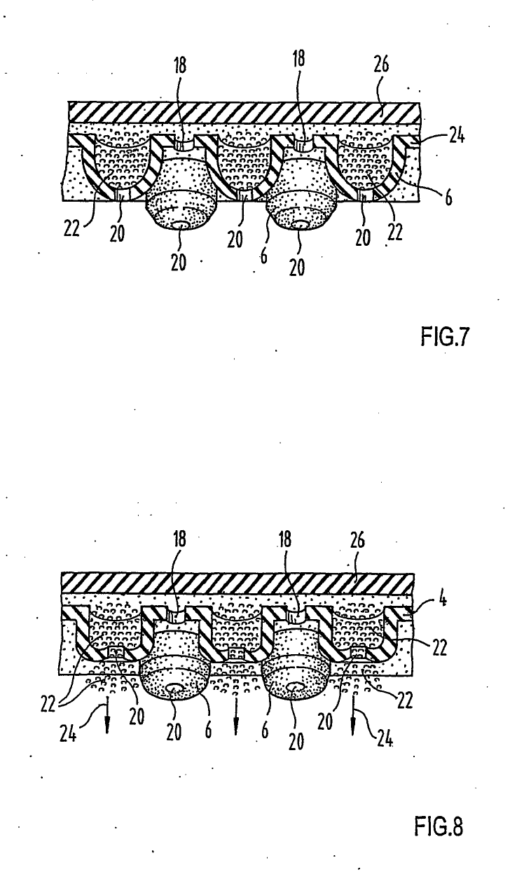

According to this embodiment, the sole 2 according to the invention has in an intermediate region between the blisters 6 and/or in the blisters 6 themselves perforations 18 or 20, by which dissipation or removal of fluid is possible in particular, but also by which the damping properties or the shock-absorbing effect is further improved. The diameters of the perforations are, for example, between 1 and 3.5 mm, preferably between 1.6 and 2.8 mm. In this respect, it may be particularly preferred to form the diameters of the perforations 18 in the base 4 of the inner sole according to the invention with a greater diameter than the perforations 20 in the blisters 6. The perforations 20 on the blisters 6 are preferably formed in the region of the tip of the dome, so that the opening formed by the perforation is provided at the lowest point. In FIGS. 7 and 8, the inner sole 2 according to the invention is represented in detail, with the removal or dissipation of fluid 22 being shown there in detail. As represented in FIG. 8, the moisture or fluid produced or present in a shoe (not represented), for example perspiration, is dissipated through the perforations 18 and 20 away from the user's foot in the direction of the arrows 24, the compressing of the blisters 6 producing a pumping effect. Preferably provided underneath the inner sole 4 is a fluid-absorbing layer (not represented), with which the fluid 22 removed can be absorbed. The contour of this layer preferably corresponds to that of the inner sole, so that the inner sole 2 and the fluid-absorbing layer lie substantially completely one on top of the other. Once the user has taken off the shoe, the fluid can evaporate out of the cushion in the reverse direction, in a direction counter to the arrows 24, through the perforations 18 and 20, so that the shoe dries out again.

This embodiment of the shoe according to the invention permits both an optimal damping effect and optimal ventilation or fluid dissipation. The definitions according to the first embodiment of the inner sole according to the invention, described with reference to FIGS. 1 to 6, also apply equally to the second embodiment of the inner sole 2 according to the invention, described in particular with reference to FIGS. 7 and 8. The same applies with regard to the selection of material.

The production of the inner sole 2 according to the invention preferably takes place by injection molding or compression molding of material, so that the base 4 and the blisters 6 of the inner sole 2 according to the invention can be integrally formed. In addition, the perforations 18 and 20 can already be formed at the same time in the molding step during production. According to a preferred embodiment, the inner sole 2 is provided as an integral element, consisting of different materials. For example, materials with a greater hardness may be integrated in the region of the heel and the ball of the foot than the remaining region of the sole during the production step.

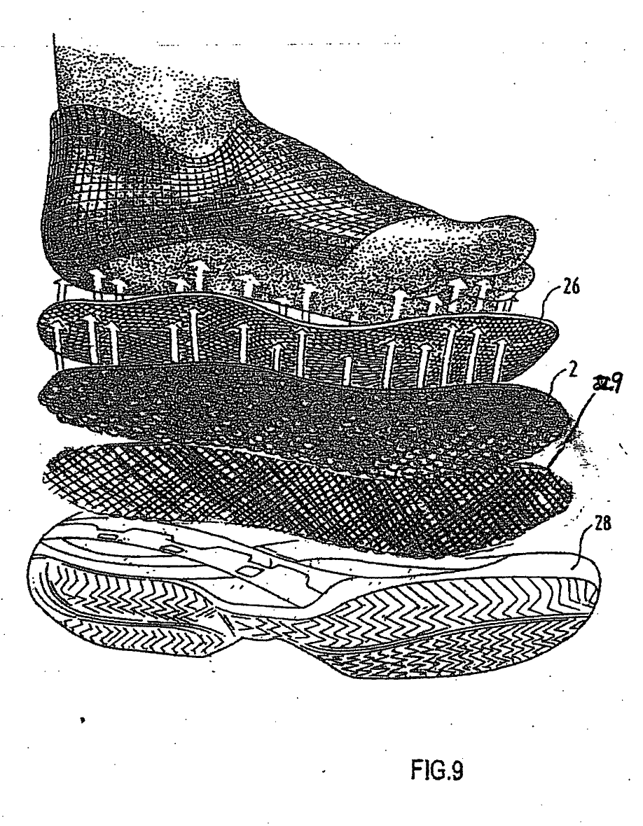

As represented in FIGS. 7 to 9, a breathable and/or moisture-permeable layer 26 is preferably applied to the upper side 10 of the inner sole 2 according to the invention. Knitted fabrics, nonwovens, cotton or polyester are suitable for example for this layer, what is known as a knitted spacer fabric being used with particular preference. This knitted spacer fabric is preferably produced from a single yam and, as a result, is particularly breathable and moisture-permeable. The knitted spacer fabric is preferably produced from a polyester material. The connection between the upper side 10 of the sole 2 according to the invention and the breathable and/or moisture-permeable layer 26 can be produced, for example, by adhesive bonding. A layer of woven fabric (not represented in the figures), which forms the surface of the inner sole, may also be applied on the layer 26. The material for the inner sole 2 and/or the layer 26 may advantageously also have antibacterial material additives. Also schematically represented in FIG. 9 is an outer sole or outsole 28. The outsole 28 is arranged underneath the inner sole 2, the blisters 6 of the inner sole 2 being directed toward the outer sole 28.

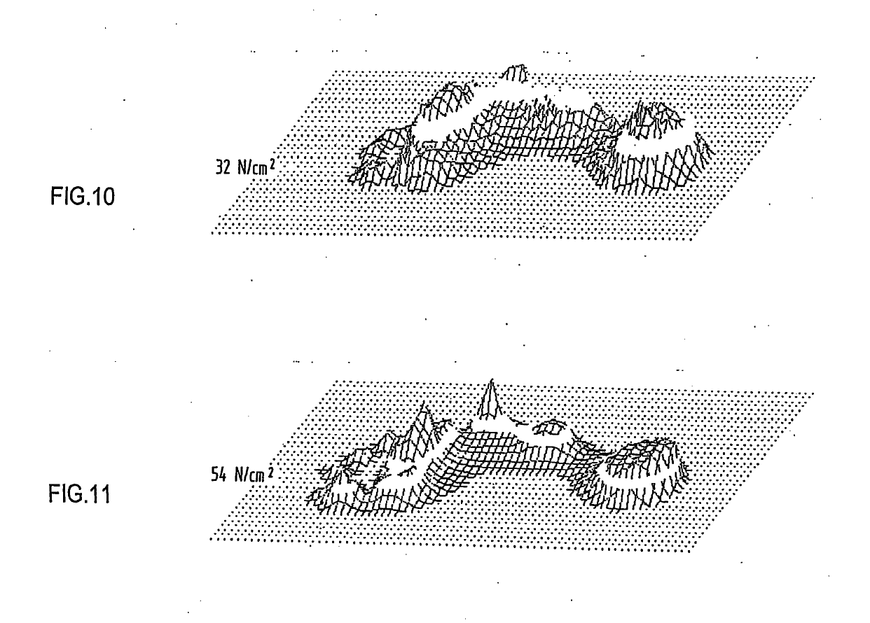

Represented in FIGS. 10 and 11 are diagrams which show the pressure distribution which act on the underside of a user's foot when the shoe has the inner sole 2 according to the invention (FIG. 10) and when the shoe is worn without the sole according to the invention (FIG. 11). These diagrams were determined in the course of orthopedic investigations. The investigation took place with an emed-SF platform with 4 sensors per cm² from the Novel company. 15 tests were carried out with test persons and the mean values were evaluated. Both a measurement under the shoe (platform measurement) and a measurement under the foot (in-shoe measurement) were performed. It was found in the platform measurement that the relatively wide heel levers the heel of the foot inward, the increased initial pronation being accommodated very well by the medial heel. As a result, the line of gait can be set in an appropriate direction. The heel-to-toe motion via the outer side of the foot and via the big toe takes place as desired. The conclusion to be drawn is that the overall stabilization of the heel is favorable and the initial pronation is great to very great. The pressure distribution determined in the in-shoe measurement according to FIGS. 10 and 11 is represented as a 3D pressure profile. The shape of the foot can be clearly seen from this. The maximum pressure occurs under the metatarsal capitula of the foot and is evident in particular in FIG. 11 from the two peaks. The peaks of this 3D profile according to FIG. 11 can be effectively accommodated by the inner sole 2 according to the invention and the foot can be loaded over a wider surface area, as shown in FIG. 10. Since the damping properties are determined by the loading, the damping is all the better the higher the loading. The inner sole according to the invention adapts to the loading, is consequently always optimally matched to the wearer, in particular its sportsman. Differently loaded regions of the foot are bedded independently of one another, whereby the foot is optimally supported.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. A process for producing an inner sole, the inner sole comprising a sole base and a plurality of blisters integrally formed with the sole base and extending away from the sole base, said process comprising the steps of:
preparing a mold with a recess for forming the sole base and the blisters, the recess having a number of projections on a first area and appropriately corresponding clearances for forming the hollow spaces on a second area lying opposite;
preparing a flexible elastic material;
introducing the material into the mold and forming the sole base and the blisters as an integral element; and
removing the inner sole from the mold.

2. The process for producing an inner sole according to claim 1, wherein the plurality of blisters of the inner sole comprises a number of blisters defining regions between themselves and extending away from the sole base and being formed integrally with the sole base, and perforations being in at least one of the regions between the blisters.

3. The process as claimed in claim 2, the mold being constructed in at least two parts and being opened for the removal of the inner sole.

4. The process as claimed in claim 2, wherein the sole includes an additional layer being at least one of the layers selected from the group consisting of a breathable layer and a fluid-permeable layer, and being applied to the upper side of the inner sole.

5. The process as claimed in claim 4 wherein the additional layer of the inner sole is adhesively bonded to the upper side of the inner sole.

6. The process as claimed in claim 2, wherein the inner sole is integrally formed from different materials in individual portions, wherein the step of introducing the material into the mold and forming the sole base and the blisters as an integral element comprises introducing the different materials substantially together.

7. A process for producing an inner sole, the inner sole including a sole base, the sole base having a number of blisters defining regions between themselves and extending away from the sole base and being formed integrally with the sole base, and perforations being in at least one of the regions between the blisters, said process comprising the steps of:
preparing a mold with a recess for forming the sole base and the blisters, the recess having a number of connecting webs between a first area of the recess and a second area of the recess lying opposite for forming the perforations in the region between the blisters and/or in the blisters;
preparing a flexible elastic material;
introducing the material into the mold and forming the sole base and the blisters as an integral element; and
removing the inner sole from the mold.

8. The process according to claim 7, wherein the inner sole has a layer for moisture absorption adhesively bonded to the top side of said inner sole opposite to where the blisters are disposed.

9. The process as claimed in claim 8, the mold being constructed in at least two parts and being opened for the removal of the inner sole.

10. The process as claimed in claim 8, wherein the inner sole further includes an additional layer being at least one of the layers selected from the group consisting of a breathable layer and a fluid-permeable layer, and being applied to the upper side of the inner sole.

11. The process as claimed in claim 10, wherein the additional layer of the inner sole is adhesively bonded to the upper side of the inner sole.

12. The process as claimed in claim 8, wherein the inner sole is integrally formed from different materials in individual portions, and the step of introducing the material into the mold and forming the sole base and the blisters as an integral element comprises introducing the different materials substantially together.

13. A process for producing an inner sole, the inner sole having different regions, and including an upper side, an underside and a sole base, the sole base having a number of blisters integrally formed with the sole base and extending away from the sole base, the blisters defining regions between themselves, and the sole base including perforations provided in at least one of the areas selected from the group consisting of the regions between the blisters, wherein each of said blisters has a hollow interior integrally formed with the sole base, and wherein a layer for moisture absorption is adhesively bonded to the upper side of the inner sole, the inner sole being formed of different materials in individual portions, said process comprising the steps of:
preparing a mold with a recess for forming the sole base and the blisters, the recess having a number of projections on a first area and appropriately corresponding clearances for forming the hollow spaces on a second area lying opposite to the first area;
preparing a flexible elastic material;
introducing the different materials substantially together into the mold and forming the mold base and the blisters as an integral element; and
removing the inner sole from the mold.

14. The process as claimed in claim 13, the mold being constructed in at least two parts and being opened for the removal of the inner sole.

15. The process as claimed in claim 13, wherein the inner sole comprises an additional layer being at least one of the layers selected from the group consisting of a breathable layer and a fluid-permeable layer, and being applied to the upper side of the inner sole.

16. The process as claimed in claim 10 wherein said additional layer is adhesively bonded to the upper side of the inner sole.

17. The process as claimed in claim 8, wherein the inner sole is integrally formed from different materials in individual portions, and wherein the step of introducing the material into the mold and forming the sole base and the blisters as an integral element comprises introducing the different materials substantially together into the mold.
